(19) United States
(12) Patent Application Publication
(10) Pub. No.: US 2020/0240870 A1
(43) Pub. Date: Jul. 30, 2020

(54) MOBILE DEVICE FOR DETECTING THE STATE PARAMETERS AND OPERATING PARAMETERS OF VIBRATING MACHINES, VIBRATING MACHINE EQUIPPED WITH SUCH A DEVICE, AND METHOD FOR DETECTING THE OPERATING AND STATE PARAMETERS OF VIBRATING MACHINES

(71) Applicant: Schenck Process Europe GmbH, Darmstadt (DE)

(72) Inventors: Jan SCHAEFER, Darmstadt (DE); Roland JOPSKI, Ruesselsheim (DE); Viktor RAIS, Muehltal (DE); Dino BOHRMANN, Mannheim (DE); Harald DITTRICH, Ginsheim-Gustavsburg (DE)

(73) Assignee: Schenck Process Europe GmbH, Darmstadt (DE)

(21) Appl. No.: 16/846,011

(22) Filed: Apr. 10, 2020

Related U.S. Application Data
(63) Continuation of application No. PCT/EP2018/074146, filed on Sep. 7, 2018.

(30) Foreign Application Priority Data
Oct. 10, 2017 (DE) 10 2017 009 373.3

(51) Int. Cl. G01M 7/02; G01M 5/00; H04W 84/18

(52) U.S. Cl. CPC G01M 7/025; H04W 84/18; G01M 5/0066

(57) ABSTRACT

A mobile device for detecting the state parameters and operating parameters of vibrating machines, which comprise sensor units and an evaluation unit connected to the sensor units, the measurement data detected by the sensor units being wirelessly transmittable to the evaluation unit, and each sensor unit being equipped with at least three acceleration sensors oriented orthogonally to each other and an integrated circuit for processing the measurement data detected by the sensor units, it is provided that at least four sensor units form a sensor network, the sensor units being detachably fastenable at a distance from each other with an undetermined orientation/direction to the vibrating machine, and a local coordinate system being defined by the at least three acceleration sensor of a sensor unit.

This nonprovisional application is a continuation of International Application No. PCT/EP2018/074146, which was filed on Sep. 7, 2018, and which claims priority to German Patent Application No. 10 2017 009 373.3, which was filed in Germany on Oct. 10, 2017, and which are both herein incorporated by reference.

### BACKGROUND OF THE INVENTION

### Field of the Invention

The present invention relates to a mobile device for detecting the state parameters and operating parameters of vibrating machines, to a vibrating machine equipped with such a device as well as to a method for detecting the operating and state parameters of vibrating machines.

### Description of the Background Art

Vibrating machines of the aforementioned type are known, for example, as vibrating screens, vibrating conveyors, vibrating dryers and the like, as well as lining-excited screens, such as flip-flow screens. They are used, among other things, for the continuous preparation of bulk materials and are characterized by an operating mode in which the structural components needed to perform the function are subjected to predetermined vibrations, the desired process result being achieved by the effect thereof on the bulk material. For example, the screen linings of vibrating screens are placed in continuous vibrating motion, which induces and intensifies the sieving operation. In flip-flow screens, the sieving operation is carried out by an alternating compression and tensioning of the screen lining. By applying a directed vibrating motion, it is possible to convey bulk goods with or without a simultaneous sieving operation. The field of application for vibrating machines extends from sieving granular bulk material to conveying and sieving ores, coal, noble metals and base metals. The latter require correspondingly large and robust machine designs.

Due to their dynamic mode of operation, vibrating machines are subjected to a continuous vibratory load, which goes hand in hand with increased wear and consequently shortens the service lives of machine parts and machine components. The components which come into direct contact with the bulk material as well as their bearing and drive components are particularly affected thereby. To prevent a total breakdown of a vibrating machine as a result of component failure and thus an interruption in the production process, vibrating machines are closely monitored during operation. The objective is to detect and evaluate the state parameters and operating parameters of a vibrating machine at predetermined time intervals to be able to detect a pending failure of components and/or parts at an early stage and, if necessary, take counter-measures in time.

A proven device in this connection is known from WO 2015/117750 A1, which corresponds to US 2016/0341629, which is incorporated herein by reference. A vibrating machine comprising a flexibly supported vibrating body and an exciter acting upon the vibrating body is described therein. A device having an inertial sensor for detecting the acceleration of the exciter is provided in the spatial axes as well as around the spatial axes for the purpose of monitoring the vibration behavior of the vibrating machine. Assuming that a vibrating machine is to be viewed as a rigid body, findings relating to vibration frequency, vibration amplitude and vibration form are obtained from the measured values with the aid of an evaluation unit, on the basis of which conclusions are drawn as to the condition of the vibrating machine.

### SUMMARY OF THE INVENTION

It is therefore an object of the present invention to obtain a preferably further indication of the condition of the vibrating machine through differentiated detection of the vibration behavior of vibrating machines. Another object is to simplify and shorten the measurement operation.

In a departure from the conventional art, which is typically based on a rigid body behavior of the vibrating machine when analyzing the vibration behavior, the basic idea of the intention is a locally differentiated detection of the vibration behavior across all relevant areas of the entire vibrating machine. For this purpose, at least four sensor units forming a sensor network are fastened in suitable locations on a vibrating machine and are connected to an evaluation unit by radio. During a measurement operation, the state parameters and operating parameters are measured in each sensor unit in relation to the local coordinate system X₁, Y₁, Z₁ defined by the particular sensor unit or its acceleration sensors, transmitted to the evaluation unit and transformed there into a higher-level uniform coordinate system X₀, Y₀, Z₀. The information about the orientation of the individual sensor units in space needed for the transformation results from the position of the vibrating plane which sets in during machine operation and from the tilt measurements of the gravity sensors of the sensor units. An evaluation then takes place based on the transformed measurement data, from which state parameters and operating parameters are derived, such as vibration frequency, vibration amplitude and vibration angle. This first results in the advantage that the sensor units may be disposed on the vibrating machine at any orientation in space and in any relative position in relation to the vibrating machine during the installation of a mobile device according to the invention. Surfaces on the vibrating machine which are suitable for fastening the sensor units may therefore be selected with the greatest possible freedom, and it is not necessary to orient the sensor units in a predetermined setpoint position during assembly. This considerably simplifies the mounting operation and also shortens the mounting times. This advantage takes effect, in particular, in large vibrating machines, which are used, for example, in heavy industry, since a large number of sensor units are mounted there, distributed over the entire vibrating machine, and in mobile devices which must be transferred from one vibrating machine to another each time they are used, which entails corresponding mounting complexity.

In this connection, it has proven to be particularly advantageous to equip the sensor units with magnetic clamps as the fasteners, which facilitates their easy and rapid fastening by placing them on the vibrating machine without any further measures.

By eliminating the need to orient the sensor units in space in the setpoint position for the measurement process, another advantage is apparent. Mounting the sensor units with insufficient care has proven to be a latent cause of measuring errors, since inadequately oriented sensor units impair the quality of the measurement results. This source of risk is eliminated with the aid of a device according to the invention, so that the measurement results obtained with the aid of a device according to the invention is characterized by a consistently high accuracy.

Since the location-specific measured values are ascertained with the aid of each sensor unit, not only is the vibration behavior of the vibrating machine as a whole detectable with the aid of a device according to the invention but it is also differentiated according to the particular mounting location of the sensor units. By suitably selecting the mounting locations, the specific vibration behavior of individual machine components, such as the screen lining, screen frame, exciter, insulation frame and the like, may be ascertained in this manner.

In this connection, the four corners of the screen frame preferably represent suitable mounting locations, in each of which one sensor may be disposed. If more sensor units are used, two sensors may be additionally disposed, for example in the center of the longitudinal sides of the screen frame, and/or two sensor units may be disposed in the end areas of the exciter cross member. However, in principle, the operator of a device according to the invention is able to freely choose the number and positioning of the sensor units.

An exemplary embodiment of the invention provides for a time-synchronous measurement in all sensor units. To synchronize the measurement operations, start signals are generated and transmitted simultaneously to all sensor units. This preferably takes place within a time window of 0.1 ms, most preferably within a time window of 0.05 ms. In one advantageous refinement of the invention, the start signal is radioed for this purpose from a communication module/gateway connected between the evaluation unit and the sensor units, preferably in the IEEE 802.15.4 standard.

Synchronizing the measurement processes opens up the possibility during the evaluation to compare the measured values of locally separated sensor units, taking into account the phase correlation. Not only is the extent to which vibration frequency, vibration amplitude and vibration angle coincide is determined in this way, but it is furthermore detected whether a phase-shifted vibration of the left and/or front part of the vibrating machine in relation to the right and/or rear part occurs. As a result, an indication is obtained as to the self-deformations of the vibrating machine and the occurrence of eigenmodes during machine operation.

The measurement data obtained in the individual sensor units can be temporarily stored in the data memories located therein and transmitted to the evaluation unit at the end of a measurement run. This has the advantage that the measurement data may be checked for plausibility and completeness prior to being transmitted, i.e. only data records found to be correct reach the evaluation unit.

To exchange data between the evaluation unit and the sensor network, a router is provided that establishes the compatibility between the sensor network and the evaluation unit. In this way, commercial computers, laptops or tablets, which generally communicate in the IEEE 802.11 standard, may be used as the evaluation unit. In the case that the sensor units use a different data transmission standard than the evaluation unit, a protocol converter is inserted into the communication chain. The router and/or the protocol converter may be integrated into the communication module/gateway, which further increases the compactness and mobility of the device.

The transformed and/or evaluated data may be output alphanumerically as calculated values. In contrast, however, the visualization thereof is preferred, for example on a wireframe model of a vibrating machine, which is output on a monitor or display of the evaluation unit. A deviating vibration behavior of the vibrating machine may be immediately detected, localized and analyzed in this way.

The exemplary embodiment relates to a vibrating machine in the form of a vibrating screen, however without being limited thereto. Subsequent embodiments apply correspondingly to other vibrating machines, such as vibrating conveyors, vibrating dryers, flip-flow screens and the like.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an oblique view of a vibrating machine according to the invention on a first longitudinal side thereof;

FIG. 2 shows an oblique view of the vibrating machine illustrated in FIG. 1 on a second longitudinal side thereof opposite the first side;

FIG. 3 shows an oblique view of a sensor unit of the device illustrated in FIGS. 1 and 2; and

FIG. 4 shows a flowchart of a method according to the invention for detecting the operating and state parameters of the vibrating machine illustrated in FIGS. 1 and 2.

### DETAILED DESCRIPTION

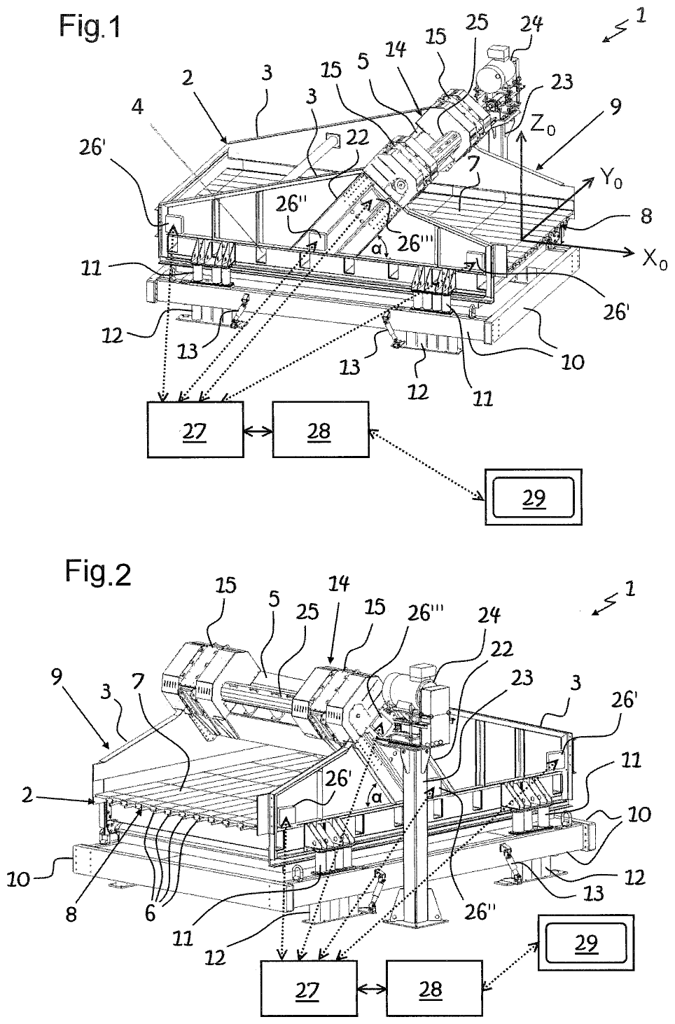

FIGS. 1 and 2 shows a vibrating machine 1 according to the invention in the form of a vibrating screen. An essential component of vibrating machine 1 is a screen frame 2, including two approximately triangular side plates 3 running plane-parallel to each other at a side distance, which are rigidly connected to each other along their base via a number of cross members 4 and in the upper area opposite the base via an exciter cross member 5. Cross members 4 form a support with their upper side for a screen deck 8 assembled from a large number of longitudinal riders 6 with a screen lining 7 disposed thereon. Screen frame 2 with screen deck 8 results in a rigid sieve box 9, which receives the bulk material and subjects it to a separating process during operation, while simultaneously conveying it linearly.

To mount sieve box 9 in a vibration-damping manner, a rectangular insulating frame 10 is provided at a distance below screen frame 2, on which screen frame 2 is supported via multiple groups of first spring elements 11. Insulating frame 10, in turn, is fixedly anchored in the substrate with the aid of second spring elements 12 and vibration dampers 13.

To generate a vibrating motion of sieve box 9, vibrating machine 1 is equipped with an exciter 14, which is rotatably mounted in bearings 15 on the ends of exciter cross member 5. Exciter 14 has a shaft, axis-parallel to exciter cross member 5, in the area of bearing 15, a toothed wheel and an unbalance mass resting on the projections on both sides thereof, and it also has a corresponding second shaft with a toothed wheel and an unbalance mass. The two toothed wheels are in meshing operative engagement with each other and thus ensure a contra-rotating rotation of the two shafts art the same rotational speed. The unbalance masses rest on the shafts in such a way that they generate a vibration pulse during their interaction, whose vector consistently encloses angle α with respect to a horizontal plane, sieve box 9 thus performing a linear vibrating motion at angle α with respect to the horizontal. To stiffen sieve box 9, reinforcing profiles 22 running in the direction of the vibrating motion extend between exciter cross member 5 and the base of side plates 3.

A rotary drive 24, which is disposed on a column 23 and rotatably fixedly abuts the first shaft via a propeller shaft, is provided at the side of sieve box 9 and insulating frame 10. An intermediate shaft 25, in turn, connects the two first shafts of exciter 5.

During operation, vibrating machine 1 is subjected to a continuous dynamic load, which make a close monitoring of the state parameters and operating parameters necessary to minimize the risk of failure. A mobile device suitable for this purpose comprises at least four sensor units 26′, 26″, 26′″, at least eight thereof in the present exemplary embodiment, a communication module/gateway 27, a router 28 as well as an evaluation unit 29, which exchange data with each other. For transport to the place of use, these components may be accommodated together in a toolbox, which may hold additional peripheral devices, such as a charging station, a rechargeable battery, a power supply unit and the like.

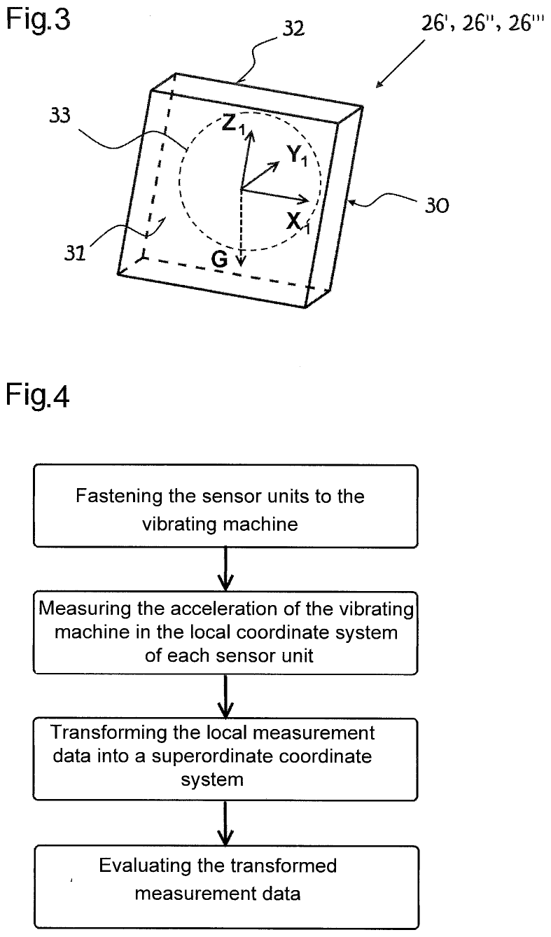

One of sensor units 26′, 26″, 26′″ is representatively illustrated in a simplified form in FIG. 3. Sensor unit 26′, 26″, 26′″ has a cuboid housing 30 with a front side 31 and a back side 32. A magnet 33 is disposed on back side 32 to detachably fasten sensor unit 26 to vibrating machine 1. Charging contacts, multiple LEDs for displaying the status as well as an ON/OFF switch—which are not illustrated—are also provided on housing 30.

Three acceleration sensors are situated in the interior of housing 30, which are designed as microelectromechanical components (MEMS) The acceleration sensors are arranged orthogonally to each other, so that their measuring axes define a local coordinate system with spatial axes X₁, Y₁ and Z₁. At least one of the acceleration sensors simultaneously has the functionality of a gravity sensor for the purpose of detecting gravity vector G in local coordinate system X₁, Y₁ and Z₁. Additional function units of a sensor unit 26′, 26″, 26′″ are a memory for temporary storage of the measurement data from the acceleration sensors, a radio module for exchanging data, at least one integrated circuit for local data processing as well as a storage unit for electrical energy.

As is apparent from FIGS. 1 and 2, a sensor unit 26′ is disposed in each of the corner areas of screen frame 2. In the present case, this is on the outside of the ends of side plates 3 directly above cross members 4 situated there. In addition, another sensor unit 26″ is situated approximately in the middle between the ends of screen frame 2, also directly above cross members 4 on the outside of side plates 3. Moreover, in each case, a sensor unit 26′″ is placed in the extension of exciter cross member 5 on the outside of side plates 3.

The detachable fastening of sensor units 26′, 26″, 26′″ to vibrating machine 1 takes place via magnets 33 on the back side of sensor units 26′, 26″, 26′″. It is not necessary to take into account a special orientation of sensor units 26′, 26″, 26′″ in space, which simplifies mounting and shortens the mounting time.

Communication module/gateway 27 controls the data traffic from and to sensor units 26′, 26″, 26′″ and performs the function of a controller/router. The radio-based communication between communication module/gateway 27 and sensor unit 26 takes place according to the IEEE 802.15.4 standard in the frequency range from 868 MHz to 870 MHz and/or 2.4 GHz to 2.483 GHz (=ZigBee).

The forwarding of the data to evaluation unit 29 takes place via router 28, which communicates with evaluation unit 29 according to the IEEE 802.11 standard in the frequency range of 2.4 GHz and/or 5 GHz (=WLAN).

To achieve a compatibility between the two standards, communication module/gateway 27 additionally has the functionality of a protocol converter; communication module/gateway 27 thus converts the incoming data into the other standard in each case. Communication module/gateway 27 and router 28 are connected to each other via a data cable for exchanging data.

Evaluation unit 29 is essentially made up of a mobile electronic data processing system, for example a laptop or tablet computer. Evaluation unit 29 includes a data input module, for example for inputting control commands, a memory module, where reference data, limiting values, measurement data from the sensor units and the like are stored, a computational module for requesting, processing and outputting data, and a data output module, for example, a display for visualizing the prepared data or an interface for forwarding the prepared data to a printer or another computer, which is connected to evaluation unit 29, for example via the Internet.

A mobile device according to the invention is suitable for carrying out resonance analyses as well as for carrying out vibration analyses. The purpose of the resonance analysis is to ascertain natural frequencies of a vibrating machine 1 in order to determine suitable operating frequencies. The vibration analysis is used to ascertain the characteristic vibration behavior of the vibrating machine during operation.

As is apparent from FIG. 4, the measurement operation in both cases begins by placing the mobile device in the measurement readiness state. For this purpose, it must be ensured that all electrical and electronic components are supplied with sufficient electrical energy for the measurement process. The components of the device must also be switched on, connected to each other and activated in the network.

Sensor units 26′, 26″, 26′″ are subsequently fastened to meaningful locations on vibrating machine 1. In the present exemplary embodiment, one sensor unit 26′ is disposed in each of the four corners of screen frame 2, preferably at the height of screen lining 7, to be able to ascertain the vibration behavior in the area of the material feeding and material discharge, differentiated according to the left screen side and the right screen side. For an indication of the vibration behavior in the middle of the screen, additional sensor units 26″ may be arranged approximately in the middle between sensor units 26′ on one machine side. Other suitable locations are the end areas of exciter cross member 5, where a sensor unit 26m is attached in the present case.

The detachable fastening of sensor units 26′, 26″, 26′″ to vibrating machine 1 takes place with the aid of magnets 33 adhering to the steel structure. Planar surfaces on screen frame 2 are particularly suitable for this purpose, for example on the outsides of side plates 3 and/or on cross members 4. The orientation of a sensor unit 26′, 26″, 26″ in space or in the plane of the fastening surface is arbitrary, since the inclination of a sensor unit 26′, 26″, 26″ in relation to the vertical is known via the gravity sensor. Gravity vector G, together with the acceleration vector, defines the vibrating plane of vibrating machine 1, from which the exact spatial orientation of local coordinate system X₁, Y₁ and Z₁ may be ascertained.

In the case of the resonance analysis, when vibrating machine 1 is at a standstill, the measurement operation is started synchronously in all sensor units 26′, 26″, 26′″ within a time window of 0.05 ms by means of a corresponding input on the evaluation unit 29, and vibrating machine 1 is subsequently placed in vibration by applying a one-time exciter pulse, for example by means of a hammer blow.

The acceleration sensors of each sensor unit 26′, 26″, 26′″ subsequently ascertain the amplitude of the acceleration as a function of the vibration frequency of vibrating machine 1 in relation to local coordinate system X₁, Y₁ and Z₁ defined by the acceleration sensors, and they store the measurement data in the local data memory for the duration of the measurement operation.

In the case of the vibration analysis, vibrating machine 1 is started before the measurement operation is carried out. Vibrating machine 1 is thus in operation during the measurement operation and vibrates at the operating frequency predefined by exciter 14. The acceleration sensors of sensor units 26′, 26″, 26′″ detect the acceleration amplitude in the axes of local coordinate system X₁, Y₁ and Z₁ and store the measurement data in the local data memory for the duration of the measurement operation.

After the measurement operation ends, the local measurement data of the gravity sensor and the acceleration sensors of individual sensor units 26′, 26″, 26′″ is transmitted in the IEEE 802.15.4 standard to communication module/gateway 27, where it is converted to the IEEE 802.11 standard and transmitted to evaluation unit 29 via router 28.

The data records of individual sensor units 26′, 26″, 26′″ are transformed into a superordinate uniform coordinate system X₀, Y₀, Z₀ in evaluation unit 29. Superordinate coordinate system X₀, Y₀, Z₀ may be, for example, an orbital coordinate system, in which the Z₀ axis corresponds to the vertical, the X₀ axis corresponds to the horizontal facing the conveying direction of vibrating machine 1, and the Y₀ axis corresponds to the lateral perpendicular to the two other axes, which is thus oriented transversely to the conveying direction. Likewise, superordinate coordinate system X₀, Y₀, Z₀ may be predefined by the vibrating motion of vibrating machine 1, in which the Z₀ axis is defined by the resulting end of the vibrating direction, at which it runs plane-parallel, the X₀ axis is in the vibrating plane perpendicular to the Z₀ axis, and the Y₀ axis, in turn, is perpendicular to the two other axes.

The transformation of the measurement data takes place based on the inclination of local coordinate system X₁, Y₁, Z₁ in the vibrating plane determined in sensor units 26′, 26″, 26′″ with the aid of the gravity sensor in each case. After the transformation has been carried out, time-synchronous acceleration data related to a uniform coordinate system, and therefore comparable, is obtained for each sensor unit 26′, 26″, 26′″ and may be converted into speed data by single integration and into path data by double integration.

Information about certain state parameters and operating parameters of vibrating machine 1 may be derived from this data, such as vibration frequency, vibration amplitude, vibration angle, phase synchronism of the vibration behavior in different locations of vibrating machine 1, and the occurrence of self-deformations during machine operation and eigenmodes of vibrating machine 1 at a standstill and during machine operation may be evaluated.

After this data is prepared in evaluation unit 29, frequency spectra, for example, with natural and operating frequencies, or the vibration behavior of a vibrating machine 1, including self-deformations and eigenmodes, may be clearly represented on a wireframe model on a display or monitor. Individual measurement data may be compared with limiting values and, if they are exceeded, an optical or acoustic warning signal may be output and much more.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A mobile device for detecting state parameters and operating parameters of vibrating machines, the device comprising:
sensor units; and
an evaluation unit connected to the sensor units, the measurement data detected by the sensor units being wirelessly transmittable to the evaluation unit, and the sensor unit being equipped with at least three acceleration sensors oriented orthogonally to each other and an integrated circuit for processing the measurement data detected by the sensor units,
wherein at least four sensor units form a sensor network, the sensor units being detachably fastenable to the vibrating machine at a distance from each other with an undetermined orientation/direction,
wherein the at least three acceleration sensors of a sensor unit define a local coordinate system X₁, Y₁, Z₁,
wherein the local measurement data detected in a sensor unit relates to the spatial axes thereof,
wherein the sensor units include a gravity sensor for detecting the orientation/direction of the local coordinate system X₁, Y₁, Z₁ in space, and
wherein the evaluation unit includes an apparatus for transforming the local measurement data into a superordinate uniform coordinate system X₀, Y₀, Z₀, taking into account the measurement data of the gravity sensor.

2. The mobile device according to claim 1, wherein the sensor network includes at least six, preferably at least eight, sensor units.

3. The mobile device according to claim 1, wherein the sensor network includes a communication module/gateway for coordinating the data flow from and to the sensor units.

4. The mobile device according to claim 1, wherein the acceleration sensors are designed as a microelectromechanical component (MEMS) or a piezoelectric component.

5. The mobile device according to claim 1, wherein the device includes a time synchronizer for the time synchronization of the measurement operations in the individual sensor units.

6. The mobile device according to claim 5, wherein a time window for the measurement operations has a duration of a maximum of 0.1 ms or a maximum of 0.05 ms, in the sensor units.

7. The mobile device according to claim 1, wherein the sensor units have a data memory for the temporary storage of the measurement data.

8. The mobile device according to claim 1, wherein the sensor units include a radio module for the wireless exchange of data, the radio frequency of the radio module being in a range between 400 MHz and 900 MHz or in a range between 2.4 GHz and 6 GHz.

9. The mobile device according to claim 1, wherein the device includes a router, which is connected between the sensor network and the evaluation unit for exchanging data between the sensor network and the evaluation unit.

10. The mobile device according to claim 1, wherein the device includes a display apparatus for the imaging visualization of the transformed measurement data.

11. The mobile device according to claim 1, wherein the device includes an energy storage unit for supplying the device with electrical energy, preferably a rechargeable energy storage unit.

12. The mobile device according to claim 1, wherein the sensor units include magnets for the detachable fastening to a vibrating machine.

13. A vibrating machine, comprising:
a device according to claim 1, and
a vibrating screen,
a vibrating conveyor; or
a vibrating dryer or a lining-excited screening machine.

14. A method for detecting operating and state parameters of vibrating machines, the method comprising the following steps:
fastening at least four sensor units, including an acceleration sensor with an undetermined direction/orientation relative to the vibrating machine, the sensor units defining a local coordinate system X₁, Y₁, Z₁ with its acceleration sensors;
measuring the acceleration of the vibrating machine in relation to the spatial axes of the local coordinate system X₁, Y₁, Z₁ at the sensor units;
transforming the local measurement data of the sensor units into a superordinate uniform coordinate system X₀, Y₀, Z₀; and
evaluating the transformed measurement data.

15. The method according to claim 14, the vibrating machine comprises:
a rectangular vibrating frame, which is formed by side plates and cross members connecting the side plates,
wherein a sensor unit is fastened at least in each of the four corner areas of the vibrating frame and/or in the end areas of the exciter cross member and/or in the end areas of the cross members.

16. The method according to claim 14, wherein the step of measuring takes place time-synchronously in the sensor units within a time window of 0.1 ms or 0.05 ms.

17. The method according to claim 14, wherein the spatial orientation/direction of the local coordinate system X₁, Y₁, Z₁ is determined based on the vibrating plane of the vibrating machine and the gravity vector.

18. The method according to claim 14, wherein the measurement data ascertained in the sensor units is transformed into the coordinate system X₀, Y₀, Z₀ predefined by the vibrating axis and/or machine axes of the vibrating machine.

19. The method according to claim 14, wherein the measurement data is visualized on a wireframe model of the vibrating machine.
